(19) United States
(12) Patent Application Publication
(10) Pub. No.: US 2008/0319822 A1
(43) Pub. Date: Dec. 25, 2008

(54) Method and system for creating and trading schedules

(75) Inventors: Tom LaJoie, Boise, ID (US); Chris LaJoise, Boise, ID (US); Derek Brauch, Manhattan Beach, CA (US); Gregory L. Bernhardt, Boise, ID (US)

Correspondence Address: STOEL RIVES LLP - SLC, 201 SOUTH MAIN STREET, ONE UTAH CENTER, SALT LAKE CITY, UT, 84111, US

(73) Assignee: Etriptrader, Boise, ID (US)

(21) Appl. No.: 12/214,714

(22) Filed: Jun. 20, 2008

Related U.S. Application Data
(60) Provisional application No. 60/945,792, filed on Jun. 22, 2007.

(51) Int. Cl. G06Q 10/00; G06F 3/14

(52) U.S. Cl. 705/9

(57) ABSTRACT

Systems and methods are provided to facilitate employees in accurately specifying and weighting preferences in the form of a bid to be used in a preferential bidding system (“PBS”) at the time schedules are created and shifts are assigned and to facilitate creating shift trade requests after schedules are created and shifts are assigned. The systems and methods present a sequence of questions to determine relative importance and weighting of criteria specified as preferences for a schedule bid and then provide a read back explaining how PBS will interpret the criteria and weighting at schedule creation. Systems and methods are also provided to display visual representation of shifts. The visual representation includes a horizontal bar that serves as a timeline. The height and/or the color of segments of the bar are changed to depict active and inactive periods of work. Systems and methods are also provide to filter, on the fly, a listing of shifts as criteria are specified as a preference for a schedule bid or as a filter criteria to identify desirable shift trades.

### CROSS-REFERENCE TO RELATED APPLICATIONS

This application claims priority to U.S. Provisional Patent Application No. 60/945,792, filed Jun. 22, 2007, which is incorporated herein by reference in its entirety.

### TECHNICAL FIELD

The present disclosure relates generally to methods and systems for creating and trading travel schedules for pilots, flight attendants, drivers, and other transportation industry employees.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a flow diagram of a user interface for specifying and prioritizing preferences as part of creating a schedule bid to submit to a preferential bid system (PBS).

FIG. 2 is an exemplary screen display presenting a listing of criteria that may be specified as preferences as part of creating a schedule bid.

FIG. 3 is an exemplary screen display listing a subset of criteria resulting from a search for a desired criterion to specify as a preference.

FIG. 4 is an exemplary screen display depicting a request for additional information to define a specified criterion.

FIG. 5 is an exemplary screen display for presenting the shifts that are included and excluded as a result of specifying a particular preference.

FIGS. 6A-6C are exemplary screen displays for presenting one or more questions to determine the relative importance of specified preferences.

FIG. 7 is an exemplary screen display presenting a read-back that explains to the employee how PBS will interpret the specified preferences in a bid when assigning shifts to create the employee's schedule.

FIG. 8 is an exemplary screen display including a schedule improvement user interface.

FIG. 9A is an exemplary screen display depicting a visual representation of a shift in the context of a list of shifts.

FIG. 9B is an exemplary screen display of a visual representation of a shift in the context of a calendar.

FIG. 9C is an exemplary screen display modeling a shift trade scenario.

FIG. 10 is an exemplary screen display for enabling an employee to specify criteria to identify desirable shifts to trade.

FIG. 11 is an exemplary screen display for presenting the shifts that are included and excluded as a result of specifying a particular criterion to identify desirable shifts.

### DETAILED DESCRIPTION

When creating work schedules, employers are often faced with the challenge of considering employee preferences, as well as a variety of other factors, such as seniority and/or priority of employees. Fairly distributing working hours requires that employees take turns working at less desirable times, and scheduling shifts is a convenient way to ensure all working hours are covered and reasonably allocated among employees. A shift may be defined generally as a period of time during which an employee is on the clock, or considered to be working for the employer, for which the employee is compensated.

In the transportation industry, shifts usually are broken out by trips. A trip generally may be described as having one or more segments of travel, the initial segment starting in one location and the final segment ending at the same location. There may be layover time, or other periods of relative inactivity, between the segments. Trips can range in duration from a few hours to several days. Examples of trips include, but are not limited to, an airline trip, a bus trip, a train trip, a trucking haul, and a cruise. In some instances the trips may include additional time before departure of the initial segment or after arrival of the final segment, such as preparation time or debrief time. Considering any pre/post-mandatory time, a trip is essentially the equivalent of a shift in the transportation industry. As with other shifts, an employee is compensated for the duration of a trip.

Systems have been developed to allow employers to efficiently and effectively consider employee preferences when assigning shifts to create employee schedules. These systems contemplate employees submitting their preferences prior to each scheduling period. Additionally, some systems further contemplate the employees prioritizing and/or weighting the preferences. When creating schedules, the systems attempt to assign an employee a schedule that most closely matches the submitted preferences. Thus, employers can feel that they are doing everything practicable to consider the wants and needs of employees when assigning shifts. Unfortunately, while there are many such systems available to empower employers in considering their employees' preferences, there is little in the way of assisting employees in defining and submitting their preferences.

Due to the wide variety and large number of criteria that may be specified as preferences, the process of wading through the numerous potential criteria to select and weighting preferences that accurately represent the employee's true preferences is tedious and time consuming, and great effort is required. Once an employee has filtered through the numerous criteria and specified the appropriate criteria as preferences, the preferences may require further definition. The criteria have their own nuances and pitfalls, making it a challenge to accurately and precisely define specified preferences. For example, specifying the criterion “Day Off” requires further defining which day of the week the employee prefers to have off. The criterion “Day Off” may not be able to be defined for more than a single day. Rather, a different criterion, “String of Days Off,” can be defined for more than a single day off. Even after accurately defining a specified preference, the process of prioritizing and/or weighting preferences relative to one another can be overwhelming. Great care and attention to detail is required because mistakes made in specifying, defining, and prioritizing and/or weighting preferences can result in an undesirable schedule that may be exactly the opposite of what the employee was hoping for.

Despite the tremendous hardship of specifying preferences, there simply is no other way for employees to obtain desirable schedules compatible with life outside of work. While many systems allow an employee to create a default set of preferences, an employee's schedule from one scheduling period to the next is not always consistent with a default set of preferences. Birthdays, weddings, family vacations, and medical procedures are only a few of the events that do not occur according to a consistent and predictable schedules. To enjoy desirable schedules and/or be available for life's important events requires actively communicating scheduling desires to the employer's scheduling system. Consequently, employees have little choice but to submit preferences. Unfortunately, the tedious and laborious effort required to prepare accurate preferences counteracts the benefit of employers even considering employee preferences.

Bypassing the bid process and simply attempting to trade shifts after schedules are assigned is not a better alternative. An employee that fails to submit a bid is likely assigned the most undesirable shifts. The most undesirable shifts are not generally good bargaining chips when trading. Moreover, wading through the hundreds or thousands of shifts to identify desirable trade targets is as tedious as specifying and defining bid preferences.

The airline industry provides one example of shift-based scheduling and airline employees are all too familiar with the challenges and difficulties inherent to submitting scheduling preferences and trading shifts. Monthly schedules for pilots and flight attendants are presently created by airlines using one of two primary methodologies: a line biding system (LBS) or a preferential bidding system (PBS). Under LBS, the company creates “lines of flying” (LOFs), which are composed of several trips of varying length throughout the month or other defined schedule period. The aircrew personnel rank the available lines and submit the rankings. Once the rankings of all personnel are submitted, an algorithm assigns a LOF to each pilot and flight attendant, taking into account seniority and other factors. The assigned LOF determines the employee's schedule for the schedule period.

Many airlines are switching from LBS to PBS because, although more complex, PBS has several advantages. One advantage is that PBS provides personnel greater flexibility and input in the scheduling process. Under PBS, personnel can select preferences for individual trips to maximize their chance of flying the types of trips desired, rather than merely ranking a full schedule. In the airline industry, a trip is essentially equivalent to a shift during a schedule period. An airline trip may be an airline-defined series of flights, the duration of which the aircrew personnel are considered “on the clock” for compensation purposes. The flights may be grouped into trip according to the location of the employee and the routes that cover the flights offered by the airline. The series of flights typically starts and ends at the same location, which is called a “domicile”.

Instead of choosing from a list of pre-created lines of flight, aircrew personnel can bid for individual trips by selecting preferences according to different criteria and assigning each preference a weight or score according to level of importance. Once all aircrew personnel load their PBS bid, the system attempts to maximize the point value for each crewmember while also considering seniority of personnel. In some cases, PBS may allow aircrew personnel to submit a “standing bid,” a separate default bid request that could be used if the employee forgets to bid any given month.

PBS is attractive in theory, but in practice, the criteria from which employees can specify preferences are simply too varied and numerous, each criterion having its own nuances and pitfalls, which leads to personnel often ending up with schedules nearly the exact opposite of what was desired. The criteria that may be considered in selecting preferences for shift selection in PBS are essentially limitless, and can be defined in numerous ways.

Some of the common criteria among airline personnel center on how the time is broken up into the different active and inactive work periods during a trip. For a pilot, these may include flight time, layover time, between-flight layover time often referred to as an “airport sit,” debrief time, and “deadhead” time. The number and distribution of these different periods of activity affects the experience of that shift for the person. For example, a shift with many short flights, with short between-flight layovers may be less desirable than a long flight with a long layover. Both may have the same amount of flight time and layover time, but the person's experience on the two different flights may vary greatly.

Considering all together multiple preferences, such as “avoid all night flying,” “desire 2-day trips,” and “maximize pay,” is complex and introduces enormous potential for pitfalls and error when personnel attempt their own scoring. Further, the process of scoring or assigning a weight for each preference can be extremely tedious and time consuming and difficult to accomplish correctly. A minor mistake in assigning weights or point values to preferences can have a devastating effect on the quality of an assigned schedule.

As an example, suppose a pilot needs Sunday, June 14th off for a daughter's wedding. Obviously, this date is extremely important and accordingly the pilot specifies a preference to have the day off and assigns the preference the maximum weight or points, i.e., 1000 points. The wedding likely is not the only preference for June, so the pilot continues to specify other criteria as preferences. For illustrative purposes, suppose the pilot specifies only one other preference. The pilot may like Saturdays off, so a preference for Saturdays off is specified and assigned a weight of 500 points. The relation between 1000 and 500 may seem appropriate for the relative importance of each to the pilot. However, if PBS can award the pilot a line with the daughter's wedding day off, but no Saturdays off, it will only score 1000 points. If there is a different line available with three Saturdays off, but not the daughter's wedding day off, that line will score 1500 points, so that is what PBS will assign the pilot. The pilot thought the preferences were accurately specified, yet the resulting schedule is disastrous.

Software programs have been developed to facilitate the creation of bids for submission to PBS, but these programs have significant shortcomings. Existing programs do little more than mimic the process as performed by hand, allowing an employee to specify preferences by selecting all the criteria that they would like to view (or not view) and then allowing each preference to be assigned a weight. As in performing the process by hand, while assigning weights to each preference the employee can easily lose track of the relative importance of criterion 1 to criterion 2 to criterion 3 to criterion 4, etc. Further, the employee can easily lose track of, for example, how criterion 2 relates to criterion 1, 3, and/or 4, and how any one of these criteria may impact the other criteria. With over 60 criteria an employee can consider when specifying preferences, as is common in PBS, it is easy for the employee to get lost and overwhelmed in the preference selection process.

Another shortcoming of existing programs is that they do not show an employee any information about which shifts have matched the preference criteria. The employee may have created rules that would never find a single shift, but the employee is left to find out only after it is too late, after the bid has been submitted and all shifts have already been awarded. The employee would certainly benefit from being able to view the number of shifts, and/or a listing of shifts, that presently match. The employee would further benefit from knowing while specifying preferences which criteria reduce the number of shifts that match the criteria, as well as the criteria that match many shifts. Existing systems do not presently offer these benefits.

After schedules are assigned, personnel may desire to modify or improve their assigned schedule by trading assigned shifts with other personnel. Also, a need to trade one or more shifts may arise for any number of reasons. For example, a conflicting event may initially be inadvertently overlooked or forgotten, or a conflict may arise after bids are submitted and schedules assigned for a schedule period.

Unfortunately, trading trips also involves many of the same pitfalls already described. Due to the large number of possible trips, identifying desirable trips to trade for in order to modify or improve a schedule can be more tedious than creating initial bids for PBS schedule creation. Similar to the process of creating bids, it is difficult to know while specifying filter criteria which criteria may reduce the number of shifts that match or the criteria that produce many matching shifts. It is even more difficult for an employee to determine how a shift trade will affect different aspects of the employee's schedule, such as pay, time off, work time, layover locations, trip efficiency (pay time/flight time), departure and arrival times, all-nighters, time away from home, deadhead time (time on a plane traveling to a destination but not on duty), and whether shifts will be worked with (or without) another specific employee.

Another challenge associated with shift trading to improve a schedule is that speed is often of the essence, as some good trips do not stay open and available longer than a few minutes. Employers generally allow shift trades during a defined shift period. Once the trading period opens, trade requests are submitted on a first-come-first-served basis. Accordingly, shift trades must be submitted as quickly as possible once a trading window opens.

Existing schedule improvement software programs are deficient, failing to address these challenges. Such programs are limited to allowing an employee to create criteria and select shifts based on the created criteria. They do not model how different scenarios will affect different aspects of the employee's schedule. Moreover, most programs require the employee to create an entire set of criteria, and then, only when the set is complete, display only the shifts that have matched. Existing schedule improvement programs also fail to facilitate an employee understanding the characteristics of an assigned schedule so as to determine whether trades might be desirable. These products typically show only columns of numbers, which must be processed and understood by the employee to compute desirability. Finally, existing products do not provide a quick or clear picture of trips available for trading, likelihood of success for a trade, or impact of a trade on the current schedule. Nor do they offer a way to quickly prepare and submit trade requests.

The present disclosure relates to techniques for addressing these challenges, and increasing the likelihood of an employee receiving a favorable schedule, by enhancing the employee's ability to specify and weight preferences and understand the effects of specifying a preference and/or giving it a particular weight when creating a schedule bid. Moreover, the present disclosure includes techniques for enhancing the employee's ability to create more accurate trade requests with better likelihood of success by providing an easily interpreted visual representation of shifts, by allowing the employee to specify criteria to filter and identify potential trades, and by painting a clear, broad picture of potential shift trades, impacts of such trades on the schedule, and the likelihood of a successful trade.

While the aforementioned scheduling challenges and difficulties are described in the context of the airline industry, they are not unique to airlines. Personnel of trucking lines, van lines, cruise lines, railroads, bus companies, and all transportation services may be faced with similar challenges when trying to take into account employee preferences when preparing schedules. In fact, any occupation with shift-based scheduling, having both desirable and undesirable shifts, is faced with a similar scheduling challenge of considering the preferences of personnel when creating schedules. Such occupations may include, but are not limited to, police and other security personnel, fire department personnel, fast food and restaurant employees, hotel employees, retail employees, and nursing and other similar healthcare related occupations.

When an employer in these industries utilizes a process of accepting bids containing scheduling preferences in order to take employee preferences into account in the scheduling process, the employees are faced with the challenges of trying to efficiently prepare accurate bids and/or shift trades. Moreover, these same employees, when desiring to improve their assigned schedule, are faced with the challenges associated with identifying and preparing accurate trade requests that are likely to succeed.

The present disclosure is directed at aiding employees in preparing precise and accurate schedule preference bids, and identifying desirable trades with a high-likelihood of success. Accordingly, one aspect of the present disclosure provides a user interface that employs a wizard style format to facilitate arranging and prioritizing monthly bid preferences. A wizard approach is easier to understand and more effective at assigning point values to criteria that will result in a better chance of an employee receiving a desirable schedule. Other aspects of the present disclosure enhance the bid creation process and/or the process of preparing trade requests.

Reference is now made to the figures in which, for the purpose of clarity, the first digit of a reference numeral indicates the figure number in which the corresponding element is first used. While the various aspects of the embodiments disclosed are presented in drawings, the drawings are not necessarily drawn to scale.

In the following description, numerous specific details of programming, software modules, user selections, network transactions, database queries, database structures, etc., are provided for a thorough understanding of various embodiments of the systems and methods disclosed herein. However, those skilled in the art will recognize that the systems and methods disclosed can be practiced without one or more of the specific details, or with other methods, components, materials, etc.

In some cases, well-known structures, materials, or operations are not shown or described in detail. Furthermore, the described features, structures, or characteristics may be combined in any suitable manner in one or more embodiments. It will also be readily understood that the components of the embodiments as generally described and illustrated in the figures herein could be arranged and designed in a wide variety of different configurations.

The order of the steps or actions of the methods described in connection with the embodiments disclosed may be changed as would be apparent to those skilled in the art. Thus, any order in the figures or detailed description is for illustrative purposes only and is not meant to imply a required order.

Several aspects of the embodiments described will be illustrated as software modules or components. As used herein, a software module or component may include any type of computer instruction or computer executable code located within a memory device and/or transmitted as electronic signals over a system bus or wired or wireless network. A software module may, for instance, comprise one or more physical or logical blocks of computer instructions, which may be organized as a routine, program, object, component, data structure, etc. that performs one or more tasks or implements particular abstract data types.

In certain embodiments, a particular software module may comprise disparate instructions stored in different locations of a memory device, which together implement the described functionality of the module. Indeed, a module may comprise a single instruction, or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

### Preparation of Schedule Preference Bids

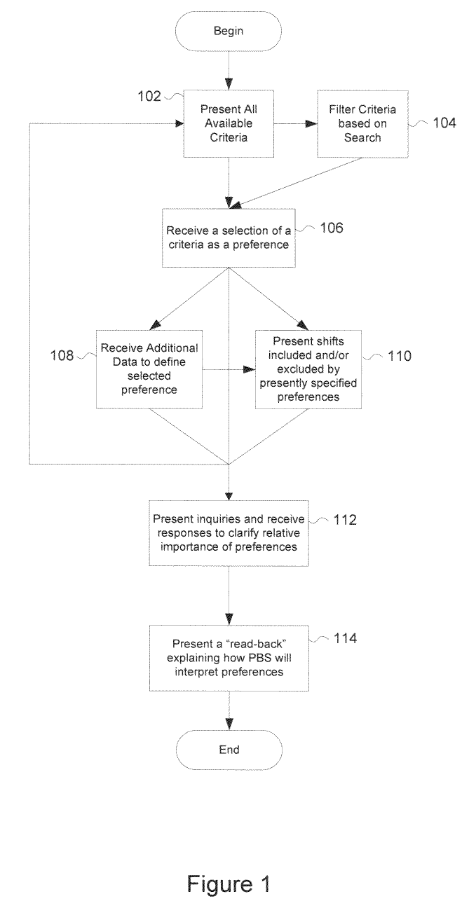

FIG. 1 is a flow diagram 100 of a wizard style user interface, or wizard, for specifying and prioritizing schedule bid preferences, according to one embodiment. The wizard first presents 102 all available criteria that may be specified as preferences. Optionally, an employee may be able to search the criteria, in which case, the list of available criteria is filtered 104 based on the search. For example, a search on the terms “day” and “off” may result in filtering out and presenting criteria such as “Day of Week Off,” “Period of Days Off,” “Specific Day Off,” and “String of Days Off.”

The employee can select 106 a criterion to specify as a preference and the wizard may request and receive 108 additional data to define the selected preference. For example, an employee may specify the criteria “Day of Week Off” as a preference and the wizard may request and receive 108 which day of the week the employee would like off to further define the preference. For some criteria there may not be additional information needed, so the wizard continues to the next step.

Optionally, the wizard may present 110 to the employee the shifts included and/or excluded by the presently specified and defined preferences. The wizard may display, on the fly as a preference is specified, a number representing the number of shifts included and/or excluded and/or a listing of shifts included and/or excluded by the specified preference. In another embodiment, the number and/or listing may display based on applying all presently specified preferences.

After specifying and defining a preference, and optionally viewing the included and/or excluded trips, the employee may desire to specify and define additional preferences. Thus the wizard may return to presenting 102 all the available criteria, and the process is repeated until all desired preferences have been specified.

With all preferences specified and defined, the wizard may present 112 a sequence of inquiries to the employee to determine the relative importance of each of the preferences. An initial inquiry may ask the employee to prioritize the preferences in order of importance, thereby forcing the employee to make an initial judgment on what is most important. A simple ranking or prioritization avoids a complicated process of assigning weights and leaving that for the wizard to do based on the employee's responses to additional inquiries. In another embodiment the employee may also be asked to assign initial relative weights to each preference, in which case the wizard may adjust the weights depending on responses to additional inquiries.

When clarifying and determining the relative importance of each preference to the next, the sequence of inquiries may give particular consideration to those preferences which occur multiple times throughout the schedule period versus those which occur singularly. Suppose the employee has specified a preference of having June 14^{th} off and a preference for having Saturdays off. An example of an inquiry to determine relative importance of these preferences might be, “How many Saturdays off would you need to equal the importance of June 14^{th} off?” If June 14^{th} is the wedding date of the employee's daughter, the employee is going to enter “0” because the wedding day is of primary importance. In this scenario, a wizard algorithm can add up the number of Saturdays in the scheduling period (in the case of a month long scheduling period, there are probably four Saturdays) and make sure that the points awarded for the maximum number of Saturdays off does not exceed the points awarded for June 14^{th} off. In another embodiment, an option may be provided in the wizard to indicate that a specific criterion is more important than all subsequent criteria. In this simple scenario the scores for each preference may be for example:

1. June 15^{th} off—1000 points

2. Saturdays off—249 points

Once the wizard has determined the relative importance of the specified preferences, it may present 114 to the employee a “read-back” or description explaining back to the employee how PBS will interpret the each preference and its relative importance to all the other preferences. The read-back describes in a few short sentences the impact of each preference as a part of the group of all preferences. The read back may be a prose style to present the preferences differently than the listing of criteria and associated defining information, thus allowing the employee to effectively review the preferences with fresh eyes and confirm whether he or she has defined and weighted the preferences as intended.

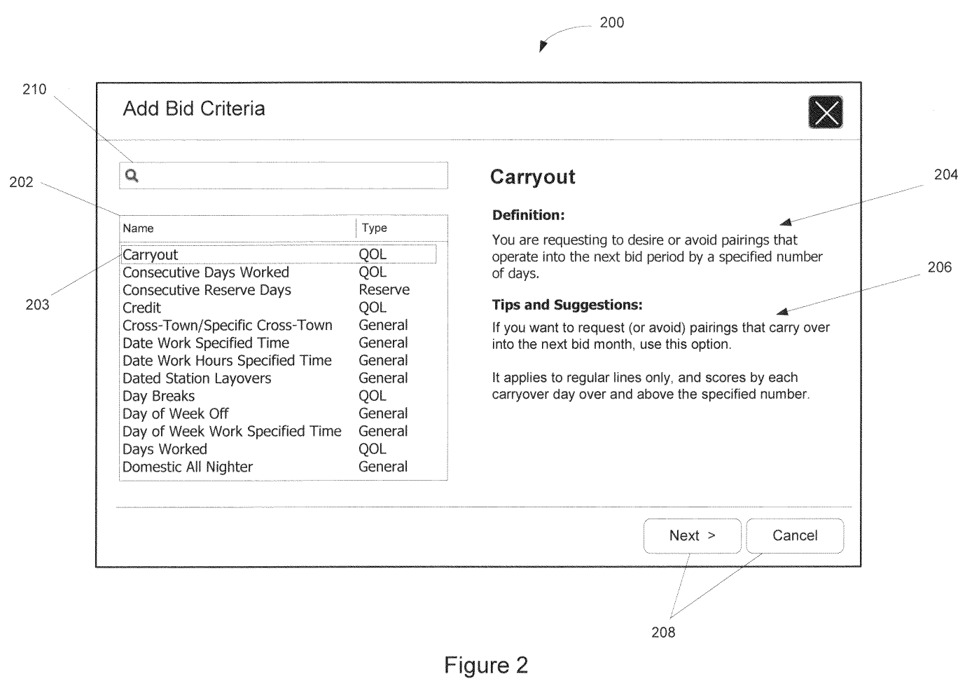

FIGS. 2-7 are exemplary screen displays of a wizard style user interface implementing the various phases of the flow diagram of FIG. 1 as describe above. These figures provide one embodiment implemented for use in the context of the airline industry, such that shifts are airline trips, and segments of a trip are individual flights. The criteria that may be specified as discussed in conjunction with the figures that follow are, in some instances, particular to the airline industry. This is in no way limiting of the invention. A person of skill in the art will readily appreciate that other embodiments may implement the invention for use in other specific industries that utilize shift-based scheduling, and still other embodiments may implement the invention more generally for use in a variety of different industries.

The display 200 of FIG. 2 presents a listing 202 of criteria that may be specified as preferences as part of creating a schedule bid to submit to PBS. As illustrated in FIG. 2, the criteria that may be specified as preferences include carryout, consecutive days worked, consecutive reserve days, credit, cross-town/specific cross-town, date work specified time, date work hours specified time, dated station layovers, day breaks, day of week off, day of week work specified time, days worked, and domestic all nighter. Examples of other criteria that may be specified as preferences are included in Table 1 below.

TABLE 1

| Criteria | Description |
|---|---|
| DATE WORK BEFORE/AFTER/DURING | Use this criteria to avoid working before, after, or during a |
| SPECIFIED TIME | requested time period on a specific date. |
| DAY OF WEEK WORK | Use this criteria to avoid working before, after, or during a |
| BEFORE/AFTER/DURING SPECIFIED | requested time period on a specific day of the week for the |
| TIME | entire bid period. |
| DAY OF WEEK OFF | Use this criteria to request a specific day of the week off for |
| | the entire bid period (e.g., Monday, Tuesday, etc.). Day starts |
| | at 01:00 and ends at 23:59 LDT. |
| PERIOD OF DAYS OFF | Use this criteria to request a complete series of days off. |
| SPECIFIC DATE OFF | Use this criteria to request a specific date off. |
| STRING OF DAYS OFF | Use this criteria to request a series of consecutive days off. |
| WEEKENDS OFF | Use this criteria to request entire weekends off. |
| DATE WORK HOURS BEFORE/AFTER | Use this criteria to maximize (or minimize) the time worked |
| SPECIFIED TIME | during a specific portion of a day. |
| WEEKEND WORK HOURS | Use this criteria to maximize (or minimize) the weekend work |
| | hours. |
| CROSS-TOWN/SPECIFIC CROSS-TOWN | Use this criteria to request (or to avoid) co-terminal pairings |
| | that start or end with a ground transport from or to a specific |
| | station. |
| DOMESTIC ALL-NIGHTER (ANF) | Use this criteria to request (or to avoid) pairings that contain |
| | Domestic ANF segments (a segment that operates during the |
| | time 02:30-03:29 LDT). |
| DOUBLE TOWN/SPECIFIC DOUBLE | Use this criteria to request (or to avoid) pairings that start and |
| TOWN | end at any coterminal station or specific co-terminal station. |
| DUTY PERIODS DURATION | Use this criteria to request (or to avoid) pairings that have a |
| | duty period less than or greater than the specified duration. |
| DUTY PERIODS DURING TIME | Use this criteria to request (or to avoid) work hours in a given |
| INTERVAL | time interval LDT. |
| EQUIPMENT TYPE | Use this criteria to avoid a specific equipment type (subfleet). |
| GENERIC FLIGHT | Use this criteria to request (or to avoid) a specific flight at any |
| | time during the bid period by specifying the flight number. |
| INTERNATIONAL PAIRINGS | Use this criteria to request (or to avoid) pairings that contains |
| | a station identified as International. |
| PAIRING ARRIVAL BEFORE/AFTER | Use this criteria to avoid pairings where the last segment |
| TIME | arrives before/after a specified time of day. |
| PAIRING DEPARTURE BEFORE/AFTER | Use this criteria to avoid pairings where the first segment |
| TIME | departs before/after a certain specified time of day. |
| PAIRING DUTY PERIOD TYPES | Use this criteria to request (or to avoid) pairings that includes |
| | a duty period of a specific type. |
| PAIRING HOUR/DAY RATIO | Use this criteria to request (or to avoid) pairings that have a |
| | ratio of credit hours/day within a specified range. |
| PAIRING LENGTH IN DAYS | Use this criteria to request (or to avoid) pairings less than, |
| | equal to, or greater than a specified number of working days. |
| PAIRING LENGTH IN CREDIT HOURS | Use this criteria to request (or to avoid) pairings that have |
| | more or less credit hours than the specified number of hours. |
| PAIRING TYPES | Use this criteria to request (or to avoid) pairings of a specified |
| | type. |
| SEGMENTS PER DUTY PERIOD | Use this criteria to request (or to avoid) duty periods with a |
| | number of segments less than or greater than a specified |
| | number. |
| SIT TIME | Use this criteria to request or avoid pairings that have a sit |
| | time(s) longer than and/or shorter than the specified |
| | durations. |
| SOFT TIME | Use this criteria to request (or to avoid) soft time hours. |
| SPECIFIC FLIGHT ON DATE | Use this criteria to request (or to avoid) a specific flight |
| | number nnnn operating on a specific date yyyy-mm-dd. |
| SPECIFIC PAIRING | Use this criteria to request (or to avoid) a specific pairing. |
| SPECIFIC PAIRINGS | Use this criteria to request (or to avoid) a range of pairings. |
| SPECIFIC PAIRING ON DATE | Use this criteria to request (or to avoid) a specific pairing nnnn |
| | beginning on a specific date yyyy-mm-dd. |
| START AT AIRPORT | Use this criteria to request (or to avoid) pairings with first |
| | active (non-deadhead) leg departing from a specified airport. |
| STATION TURN | Use this criteria to request (or to avoid) flying through a |
| | specific station. |
| STOP AT AIRPORT | Use this criteria to request or to avoid pairings whose last |
| | active leg (nondeadhead) arrives at a specified airport. |
| TAFB | Use this criteria to request (or to avoid) time away from base. |
| Dated Station Layovers | Use this criteria to request (or to avoid) a layover at a specific |
| | station on a specific date for a specific length of time. |
| Layover Arrival Before/After Time | Use this criteria to avoid duties that arrive before or after a |
| | specified time of day. |
| Layover Departure Before/After Time | Use this criteria to avoid duty periods with early/late |
| | departures. |
| Layover Length/Specific Layover | Use this criteria to request (or to avoid) pairings that have a |
| Length | layover shorter or longer than a specified duration. |
| Early PC/PT | Use this criteria to request a training event in your early |
| | month. If this bid option is not used, the system automatically |
| | assumes you want to avoid a training event in your early |
| | month. |
| PC/PT Group Operating On Date(s) | Use this criteria to request or to avoid a training event |
| | operating on a specific date or on a range of dates. The |
| | training event does not have to be contained within this date |
| | range - it just has to touch at least one of the dates in the |
| | range. |
| PC/PT Group Starting On Date(s) | Use this criteria to request or to avoid a training event starting |
| | on a specific date or on a range of dates. |
| Train With | Use this criteria, as a First Officer, to request or to avoid |
| | training with a Captain as specified by the Captain's file |
| | number. |
| Training On a Double F/O Unit | Use this criteria, as a First Officer, to request or to avoid |
| | training with another First Officer (unpaired crew). |
| Carryout | Use this criteria to request (or to avoid) pairings that operate |
| | into the next bid period by a specific number of days. |
| CONSECUTIVE DAYS WORKED | Use this criteria to avoid working more than a specified |
| | number of consecutive days. |
| Credit | Use this criteria to request (or to avoid) credit hours. |
| DAY BREAKS | Use this criteria to avoid day off periods less than a specified |
| | number days. |
| DAYS WORKED | Use this criteria to avoid working days over a specified number |
| | of days. |
| INTERNATIONAL TIME | Use this criteria to request or to avoid international time pay. |
| LINE CREDIT VALUE | Use this criteria to request a line with total credit hours higher |
| | or lower than a specified value or between two specified |
| | values. |
| NIGHT TIME | Use this criteria to request (or to avoid) night time pay. |
| PAIR WITH | Use this criteria, as a First Officer, to request (or to avoid) |
| | flying with a Captain specified by the Captain's file number. |
| PAIR WITH RESTRICTED CAPTAIN | Use this criteria, as a First Officer, to avoid being paired with a |
| | restricted Captain. |
| PAIRINGS | Use this criteria to request (or to avoid) any pairings in the bid |
| | period. |
| TIME OFF BETWEEN ASSIGNMENTS | Use this criteria to avoid any rest in domicile less than a |
| | specified number of hours. |
| WORK ON DATE | Use this criteria to request (or to avoid) work on a specific date |
| | of the bid period. |
| WORK PERIOD RELEASE TIME AFTER | Use this criteria to avoid pairings with a late release time |
| TIME | before a calendar day off in domicile. |
| WORK PERIOD REPORT TIME BEFORE | Use this criteria to avoid pairings with early report times after |
| TIME | a calendar day off at a domicile. |
| WORK PERIODS | Use this criteria to minimize the number of work periods in the |
| | bid period. |
| CONSECUTIVE RESERVE DAYS | Use this criteria to avoid being on reserve for more than a |
| | specified number of days. |
| HOLY DAY | Use this criteria to request a specific date to be within the 6 |
| | day Holy Day period. |
| RESERVE DAY OF WEEK ON | Use this criteria to request a recurring day of the week on |
| | reserve. |
| RESERVE LINE | Use this criteria to request a reserve line. |
| SPECIFIC DATE ON | Use this criteria to request a specific date on reserve. |

An employee may highlight a particular criterion 203 and the display 200 may provide a definition 204 of the criterion to enable the employee to best understand the meaning and purpose of that criterion. The display 200 may also provide one or more tips and suggestions 206 with each criterion to help the employee know what other criteria are similar and may be better suited as a preference for particular situations. Hyperlinks may be provided to enable quick substitution or addition of such other criteria. Navigation buttons 208 may be provided for advancing through the wizard. The display 200 may further include a search field 210 into which the employee can enter search terms to filter and more easily identify desired criteria.

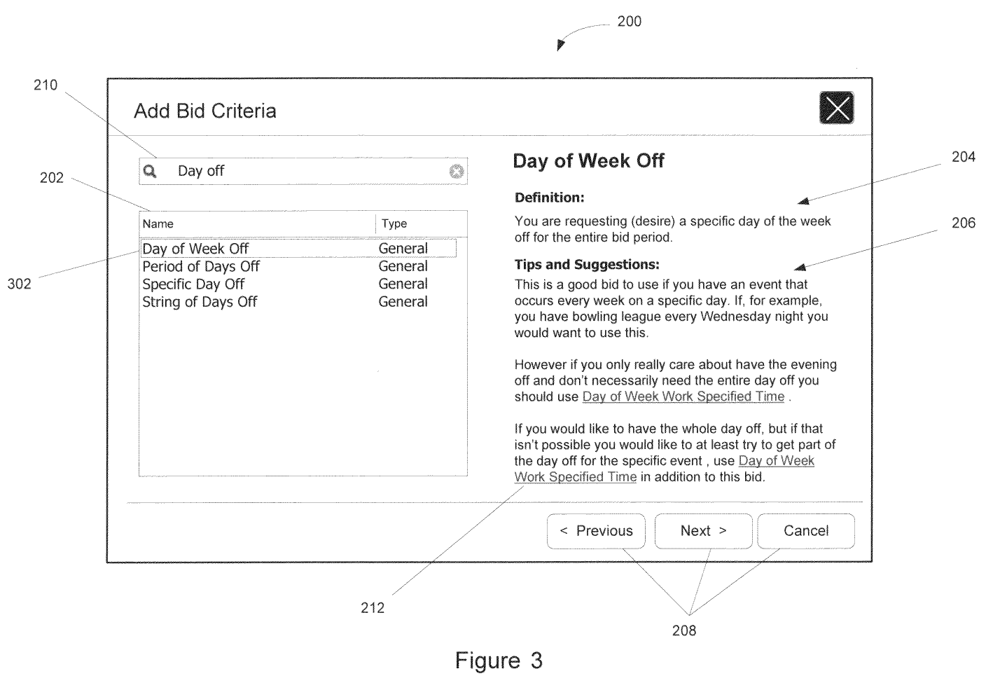

FIG. 3 is the screen display 200 of FIG. 2 listing a subset of criteria resulting from a search for a desired criterion. The search terms “day” and “off” are shown entered into the search field 210. The employee may have entered the search terms, clicked the “Next >” navigation button 208, and the listing 202 of criteria was filtered and is displayed. The criteria “Day of Week Off” 302 is shown highlighted, and a definition 204 and tips and suggestions 206 are displayed for that criteria. The tips and suggestions 206 include related criterion that may be better suited to represent the employee's desired preference. For example, the criterion “Day of Week Work Specified Time” 212 is offered as a related criterion for a situation when the employee does not need an entire day off for an event, but rather needs a part of a day off. The figure illustrates that the related criterion 212 can be hyperlinked to allow the employee to quickly substitute a related criterion for the currently highlighted criterion.

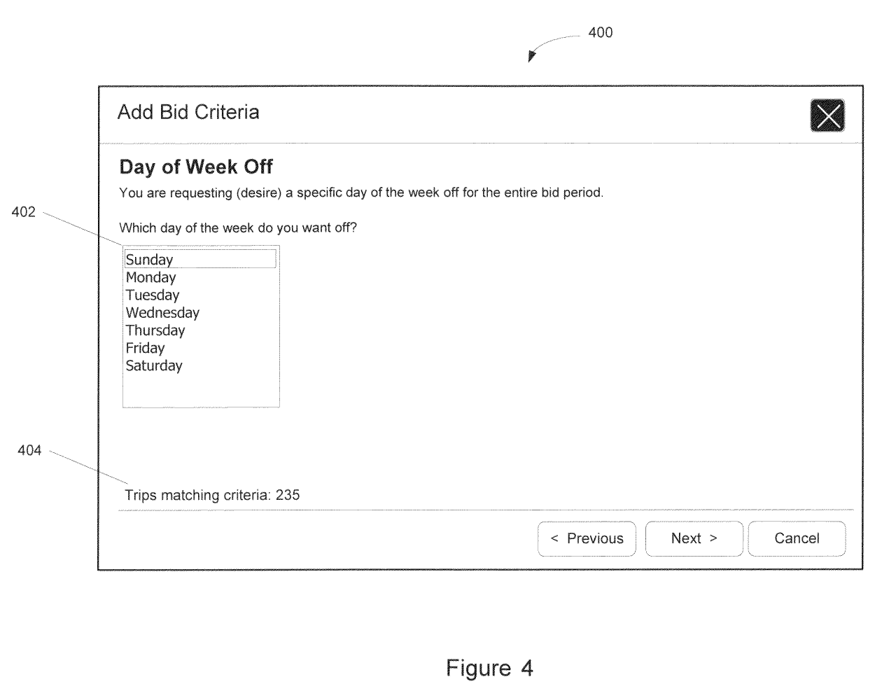

FIG. 4 is an exemplary screen display 400 requesting additional information to further define a specified criterion. In the figure, the criterion specified as a preference was “Day of Week Off.” The display presents a listing 402 of the days of the week to enable the employee to define which day of the week the employee prefers to have ‘off.’ Sunday is shown highlighted. When a particular day, such as Sunday, is selected, the display 400 presents to the employee the number of trips 404 that match the criteria. Thus the employee can quickly see the number of trips available that match the preference as defined, and quickly assess the likelihood of successfully trading for such a matching trip. If the likelihood is low, the employee may choose to define the preference differently, such as by specifying a different day of the week, or select a different preference. The number of trips 404 may represent simply the trips that match the preference presently being defined. In another embodiment, the number of trips 404 may represent the trips matching all previously defined preferences as well as the preference currently being defined.

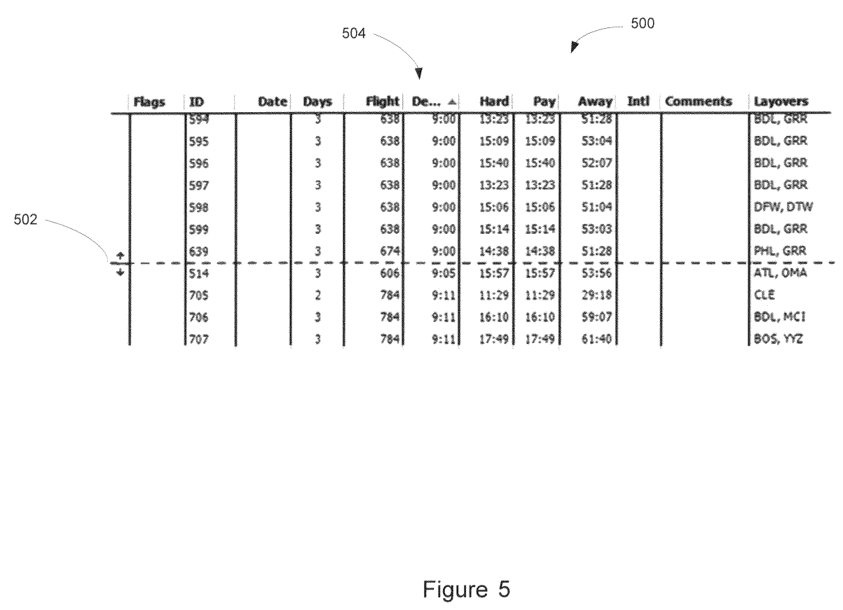

While arranging a list of preferences for the month's schedule, the wizard can optionally present the employee with a listing of included shifts as illustrated by the exemplary screen display 500 of FIG. 5. The display 500 is shown presenting the shifts that are included as a result of specifying a particular preference. The display 500 may also present the shifts that are excluded by that preference. The display 500 may be presented and/or updated on-the-fly, as the employee specifies each preference. The shifts are arranged by proximity to the preference specified so as to provide an immediate reference for which shifts are being included or excluded as a result of the specified preference. The display 500 listing the included shifts may be presented as part of the wizard display to give the employee immediate notice of what shifts the employee is including or avoiding. In another embodiment, the display 500 listing the included shifts may be presented as a pop up feature.

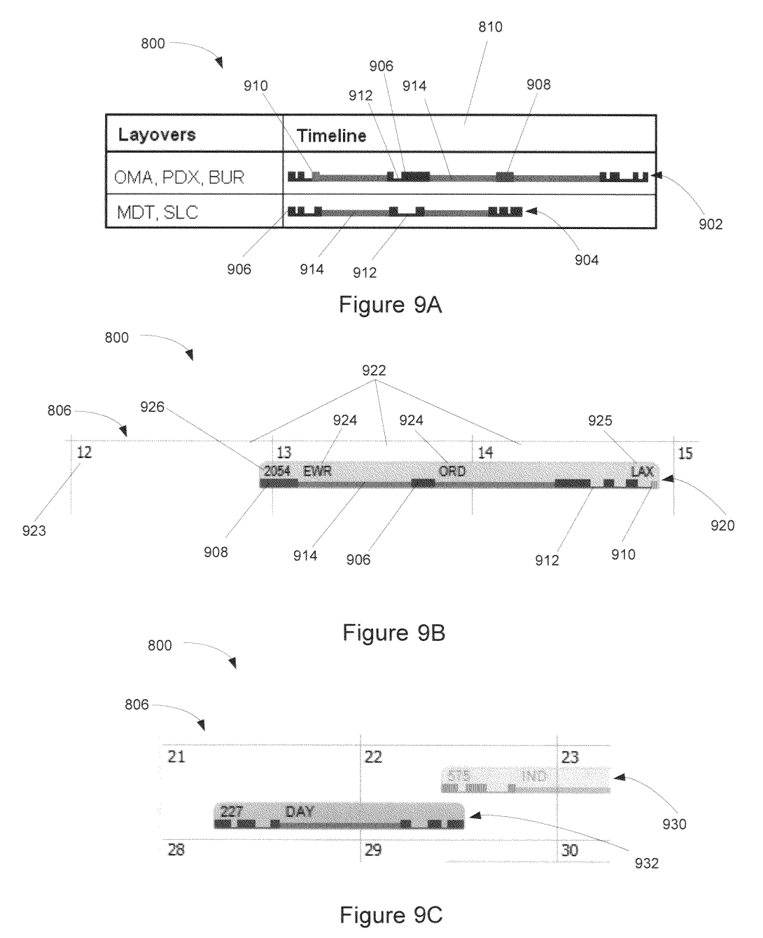

The list of included shifts presented by display 500 of FIG. 5 is organized in a table format with rows of the table representing trips. Columns of the table provide attributes of the trips, such as trip ID, date, number of day (for duration of the trip), departure time, hard time (the actual scheduled flight hours to be flown), soft time (the time beyond the hard time that the employee is scheduled to be paid for the trip), pay time (the time for which the employee is paid), away time (the time away from the domicile), and whether the trip is an international trip. In addition, a column 504 provides the trip departure time. Another column may provide a visual representation of the shift in the form of a timeline, such as the visual representation depicted in FIG. 9A and discussed below. The trips are ordered according to proximity to the criteria and a divider 502 separates the matching (included) trips from those that do not match (excluded). The employee can readily see the excluded trips that are closest to matching the preferences, thereby enabling the employee to quickly determine if the preference should be modified to include one or more of the excluded trips.

For example, if the employee does not like early mornings, the preference “Avoid Departures Before” may be specified and defined to exclude preferences before 0900. As depicted in FIG. 5, the list of all the available trips will be prioritized relative to 0900 departures allowing the employee to quickly assess if any trips that may be desirable will be excluded. There may be a trip that leaves at 0859, but that is a desirable trip with layovers. The employee can immediately adjust the preference to “avoid trips leaving before 0859” and thus not exclude the desirable shift. The employee may be able to modify the preference by clicking and dragging the divider 502 to include the desired trips.

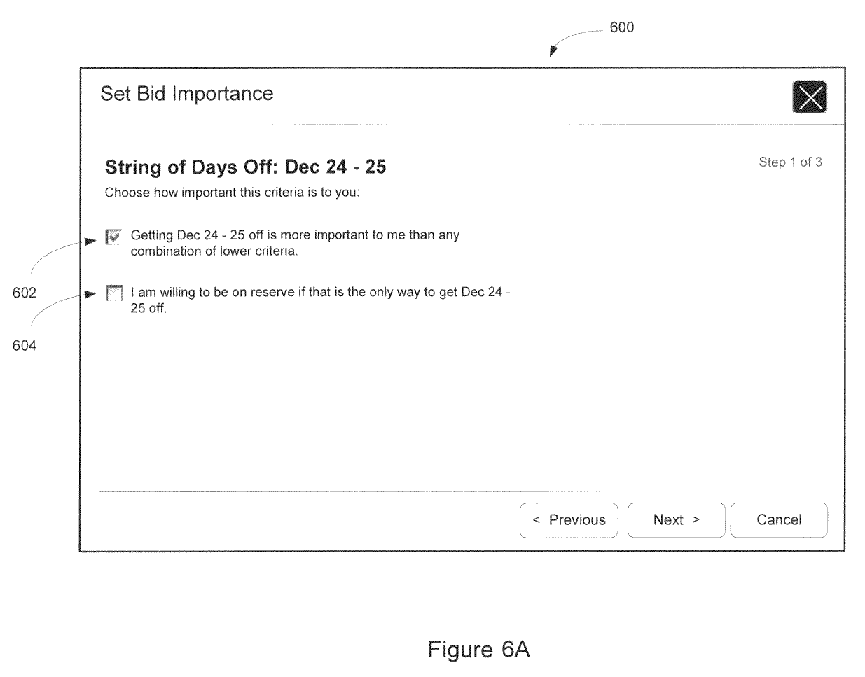

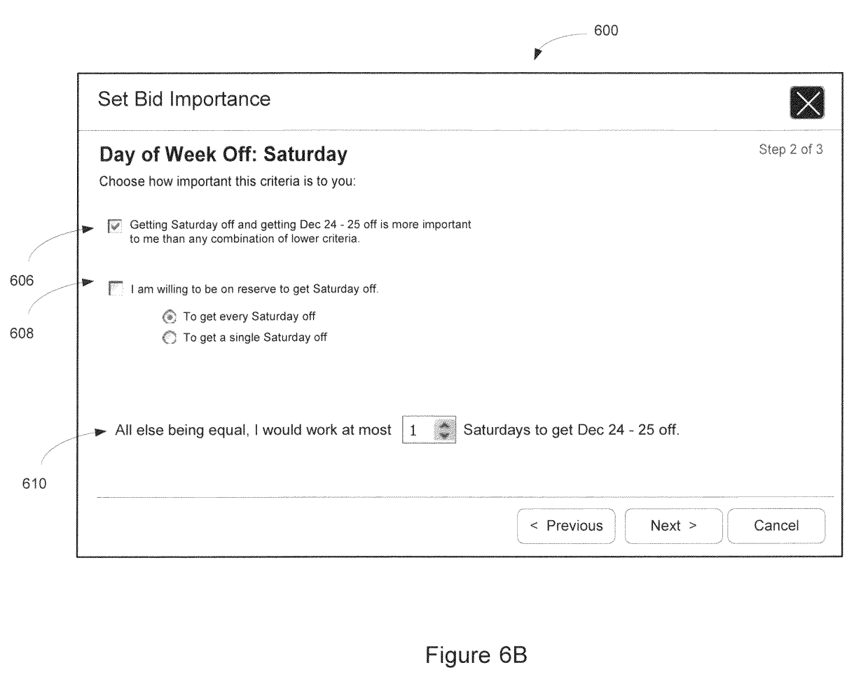

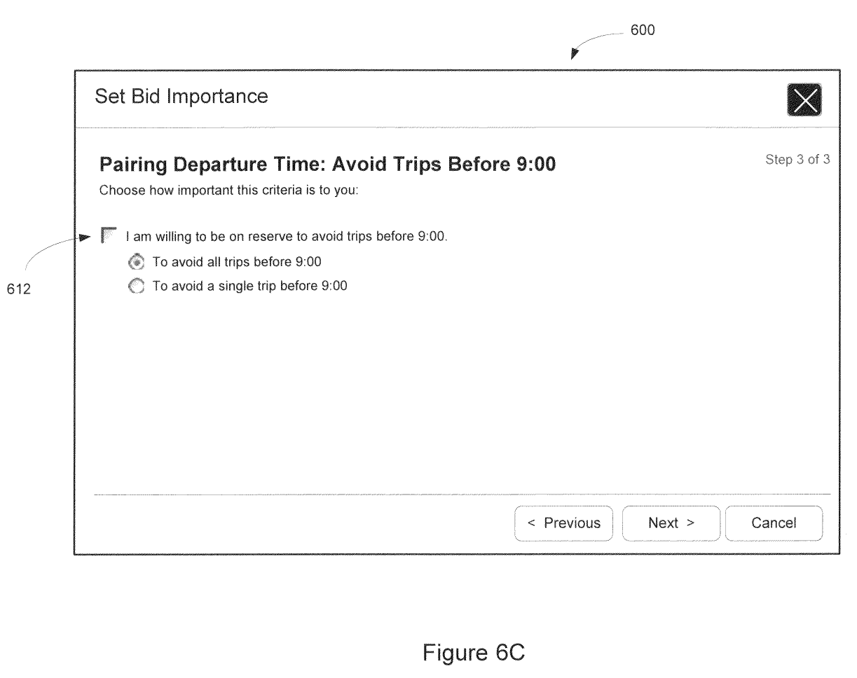

FIGS. 6A-6C are exemplary screen displays 600 presenting a sequence of inquiries designed to determine the relative importance of the specified preferences of an example scenario. The questions may also be used to determine whether or not the employee desires some aspect of their schedule enough to be “on reserve” for the entire month. Personnel that are on reserve only know which days of the month they must be available for possible flights to be assigned by the company at a later date. An airline typically schedules a percentage of its personnel, for example 80% of its pilot and aircrew workforce, as “line holders” who have been assigned a line of flying (or a schedule). The remaining percentage of personnel are “on reserve.”

As indicated in FIG. 6A, an employee in the example scenario may have specified a preference “String of Days Off” and defined it to prefer December 24^{th} and 25^{th} off to be home for the Christmas holiday. The employee may be asked, for example by inquiry 602, to specify whether this preference is more important than any combination of lower criteria. An inquiry such as 602 may be an indirect way to determine which preference is most important and should receive “eclipse priority,” which gives it more weight than any combination of lower preference. Another inquiry 604 may ask whether the employee would be willing to be on reserve to get Saturdays off. If the preference is very important, the check box next to this inquiry will likely be checked to indicate that the employee is willing to completely forgo a pre-established schedule to get Saturdays off. Checking this box may raise the priority or weight of the preference. Moreover, it may be interpreted by PBS as permission to schedule the employee for reserve time to assign a schedule that matches one or more preferences.

As depicted in FIG. 6B, the employee may also have specified “Day of Week Off” as a preference and defined it to prefer Saturdays off. To accurately weight the preferences, the wizard must know the relative importance of these preferences. As depicted in FIG. 6B, the wizard can present the employee with an inquiry 606 to determine whether getting Saturdays off is as important as getting Christmas off. If the employee had not specified that Christmas was more important than all lower criteria (on the display of FIG. 6A), inquiry 606 may simply inquire whether getting Saturdays off is more important than all lower criteria. Inquiry 608, like inquiry 604, determines whether the employee is willing to go on reserve to get Saturdays off. Finally, inquiry 610 can further clarify relative importance by asking the employee to indicate how many Saturdays off are the equivalent of getting Christmas off. There are multiple Saturdays in a scheduling period. A preference occurring in multiple instances may not be accurately weighted relative to other preferences without some understanding of how many instances of the multiple-instance preference are equivalent to other preferences. In FIG. 6B, the employee has indicated that he or she is willing to work at most 1 Saturday to have Christmas off.

As depicted in FIG. 6C, the employee may have specified a third preference for “Pairing Departure Time,” which is the time of day the first flight of a trip departs, and defined it to prefer Avoiding Trips before 9:00 am. In this example scenario, the preferences for “String of Days Off” and “Day of Week Off” were processed first. The employee may have provided an initial ranking and/or weighting to indicate that these preferences were more important than “Pairing Departure Time.” In another embodiment the criteria may be categorized, and the wizard algorithm knows to process the preferences in the various categories in a particular order once specified by the employee. Regardless, the wizard determined that the only information necessary to determine relative importance of the preference “Pairing Departure Time” is to present an inquiry 612 to find out if the employee is willing to be on reserve to avoid trips before 9:00. Because the preference may occur multiple times, additional inquiry may be made to determine whether the employee is willing to go on reserve for a single instance of the preference or only for all instances.

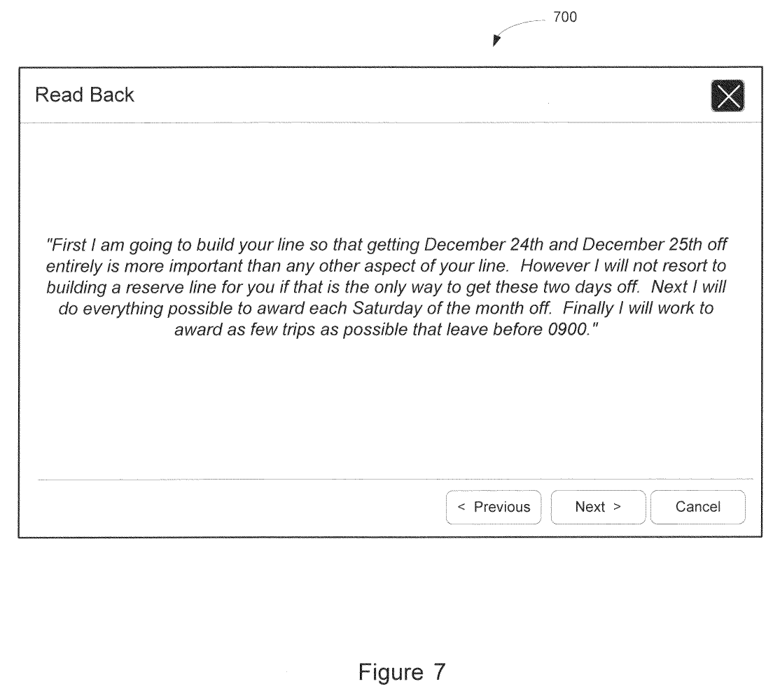

Once all the questions are completed, the wizard provides the employee with a plain English (or other desired language) “read back” explaining in prose how PBS understands the specified preferences and what will be guiding PBS when building the employee's schedule for the period. FIG. 7 is an exemplary screen display 700 presenting a read back. For example, as depicted in FIG. 7, a pilot's read back may read, “First I am going to build your line so that getting December 24th and December 25th off entirely is more important than any other aspect of your line. However I will not resort to building a reserve line for you if that is the only way to get these two days off Next I will do everything possible to award each Saturday of the month off Finally I will work to award as few trips as possible that leave before 0900.”

An example of a slightly more complex read back may read “First I am going to do whatever I can to build a line with July 4th off, even if it means awarding you a reserve line. Next I am going to seek to get July 3rd and July 5th off equally, but will take one off if I cannot get the other and will not award a reserve line to get these days off I will then seek to award every Sunday off equally in the month and will seek to avoid all night flying. If faced with a decision between a line with an extra Sunday off and two trips with all night flying or a line without the extra Sunday and two fewer all night flying trips I will choose to build the line working the extra Sunday and two fewer all night trips. Lastly I will attempt to build a line with as many credit hours as possible but in doing so will not violate any previous requests.”

The read-back may not add new information, but the repetition of the information is valuable because it pulls back from the precise details that the employee has been enduring in selecting criteria to specify as preferences and providing further definition, and then in responding to the relative importance inquiries. The read-back gives a broader re-look at the resulting preferences in plain English so that the employee has opportunity to think things through again. The re-look is especially an effective opportunity for the employee to identify any obvious mistakes, such as “desiring” instead of “avoiding” trips with departure before 0900.

Generally, a criterion that has the “eclipse priority” box checked may be read back in a “ . . . will do everything possible to . . . ” format. Criterion that are related in proportion to other criteria will be read back so as to clearly state the proportions. For example, “I will look to minimize Saturdays worked but where I can achieve two Sundays off and the expense of 1 Saturday off I will do so.”

The employee may confirm the read back is accurate or go back and modify the preferences to be more accurate. When the employee's bid preferences are settled, the employee may submit the bid to the employer's PBS for the schedule creation process and then wait to receive an assigned schedule.

### Shift Trading for Schedule Improvement

After an employee has received an assigned schedule there may be reasons for the employee to trade shifts to improve the assigned schedule. Unexpected conflicts commonly arise that require an employee's schedule to be modified. Moreover, although a scheduling system may consider employee preferences, no system is perfect at assigning schedules that completely satisfy employees. Despite there being numerous criteria available to be specified as preferences in PBS, there are intangible employee desires that cannot be specified as preferences within the available criteria, which, if met, can dramatically improve job satisfaction and quality of life. For example, there may not be a way to submit a preference to PBS for “a trip to Mexico in late Spring with a long layover on a weekend so that my spouse can accompany me for a short vacation.” While this desire is difficult to submit as a specified preference to the PBS scheduling system, an employee can seek to trade for a trip matching that desire.

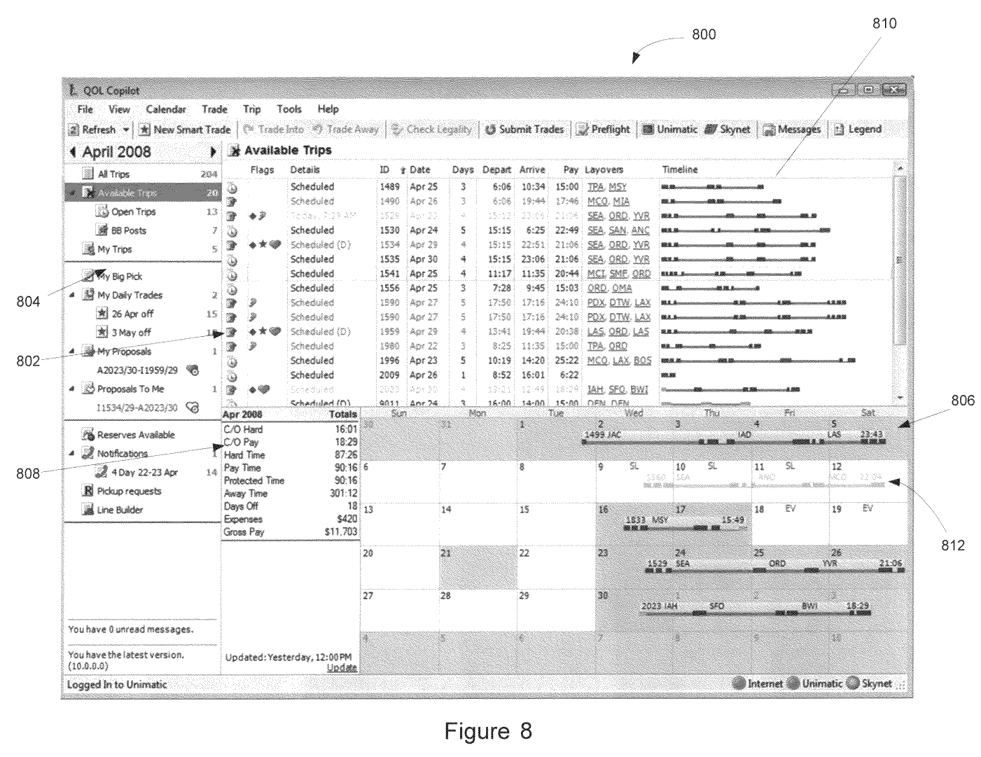

FIG. 8 is an exemplary screen display 800 presenting a schedule improvement user interface. As shown, display 800 may include a shift listing pane 802, a calendar 806 showing the scheduling period and the employee's presently assigned shifts and desired trades, and a shift summary pane 808 summarizing the time and pay impacts of displayed shifts.

Display 800 also provides a visual representation of each shift that depicts aspects of the shift to enable an employee to quickly understand whether the shift is desirable or undesirable. A visual representation of one or more shifts may be included as a part of a listing of shifts displayed in the shift listing pane 802. A column 810 of the listing of shifts being displayed in the shift listing pane 802 provides such a representation. A visual representation of one or more shifts may also be superimposed on the calendar 806 to further communicate actual timing of the shift and of the active and inactive work periods of the shift.

FIG. 9A depicts a close-up view of two visual representations of shifts 902, 904 in the context of a list of shifts. A portion of the display 800 of FIG. 8 is depicted presenting two rows and two columns of a listing of shifts, including a portion of column 810. As shown, a visual representation as provided in column 810 is a horizontal bar that serves as a timeline. Horizontal positioning along the bar is proportional to time. The length of the bar is proportional to the duration of the shift. The height and/or color of segments of the bar are changed to represent different active and inactive work periods, and the timing of such, during the shift. In another embodiment, the texture or pattern of the bar may also be varied to represent different active and inactive work periods. The horizontal positioning along the bar of height and/or color changes communicates relative timing and duration of the represented work periods.

The segments of varying height and/or color enable an employee to quickly view and understand the characteristics of a shift. For example, the visual representations 902 and 904 depicted in FIG. 9A represent airline trips. Work time during a flight is shown as tall blue segments 906 of the bar. Work time during a flight through the night appears as tall red segments 908 of the bar. Deadhead time appears as medium-tall orange segments 910 of the bar. Between-flight “sits” or layovers are shown as short blue segments 912 of the bar. Layover time is shown as medium-short green segments 914 of the bar.

A pilot looking for trips with particular characteristics can quickly determine whether a shift has such by looking at the visual representation of the shift. For example, a pilot desiring trips with long flights and long layovers can quickly compare the relative length of the medium-short green segments of the timeline. The shifts represented by visual representations 902 and 904 both have relatively long green segments indicating layovers. A pilot looking for shifts with long flights, rather than a series of short flights, can look for shifts with long segments of tall blue bar, rather than a series of short segments of tall blue bar. The shift represented by visual representation 902 has a relatively long flight during the day as well as a relatively long flight through the night. A pilot looking for, or looking to avoid, flying through the night can easily identify segments of tall red bar. Again, the shift represented by visual representation 902 has a flight through the night represented by a tall red segment 908. As illustrated, by representing the various activities of a shift by varying color and/or height of the horizontal timeline bar, an employee can quickly compare the various characteristics of shifts simply by scanning the timeline column 810 and comparing the visual representations provided therein.

Visual representations of shifts other than airline trips are also possible. As mentioned previously, numerous industries and employers utilize shift-based scheduling, and the different active and inactive work periods of the shifts can be represented on a timeline. Personnel of trucking lines, van lines, cruise lines, railroads, bus companies, and other transportation services may benefit from visual representation of potential work shifts. Employees in other occupations with shift-based scheduling may also benefit from visual representation of potential work shifts. Such occupations may include, but are not limited to, police and other security personnel, fire department personnel, fast food and restaurant employees, hotel employees, retail employees, nursing and other similar healthcare related occupations, and any occupation for which schedules are created according to assignment of shifts.

When representing the various types of shifts of these industries and occupations, varying the height and/or color of the horizontal bar can represent different active and inactive periods of the shifts, including such periods as normal work time, break time, on call time, working travel time, working travel time during a trip through the night, non-working travel time, layover time, between-segment layover time, and debrief time.

A visual representation of a shift may also be viewed in the context of a calendar. FIG. 9B depicts a close-up view of display 800 presenting a visual representation of a shift 920 in the context of calendar 806. The display 800 can superimpose the visual representation on the calendar 806 to enable an employee to easily approximate the actual timing of a shift in addition to the length of the shift. An employee can also quickly ascertain what segment of a shift occurs on a given date.

The calendar 806 may include one or more sequentially positioned day cells 922 that represent one or more days of a schedule period. An indication of the day represented 923, such as the day of the month or day of the week, is provided in each day cell. Horizontal position within a day cell 922 is proportional to time of day. Thus, a horizontal timeline bar can begin at a horizontal position within a day cell that corresponds to the actual time of day that the shift begins. For example, if the represented shift begins at 12:00 noon, the timeline bar can begin at the horizontal center of the day cell. Similarly, the bar can end at a horizontal position within the day cell corresponding to the time of day that the shift begins. The bar may extend through multiple day cells indicating that the duration of the trip is multiple days. The different segments of the bar, as indicated by varying height and/or color to depict different active and inactive periods of work, can also begin and end at positions within a day cell that correspond to the actual time of day that the active or inactive work period begins and ends.

FIG. 9B also illustrates that additional information can be added to a visual representation of a shift. A label 924 can indicate a layover city. Another label 925 can indicate a departure or arrival airport. A label 926 can also display a shift ID. The label 924 providing the layover cities may be displayed on or near the segments 914 of the bar representing layovers. An employee can quickly identify a long green bar segment 914 of medium height with the letters “MEX” as a long layover in Mexico. A departure or arrival airport can be quickly ascertained from a label on or near the appropriate end of a tall blue segment 908 of the bar representing work in flight. The shift ID label 926 allows for easy cross-reference to the listing of shifts. Additional information that could be added, but that is not depicted in FIG. 9B, includes textual display of shift start time, shift duration, and shift end time, indication of whether the shift has been assigned to an employee, and indication of which employee is assigned the shift.

Referring again to FIG. 8, in one embodiment the calendar 806 may enable an employee to model multiple scenarios of shift trades, select part or all of each scenario, and view in the summary pane 808 exactly how the selected portion of the selected scenario will impact important aspects of the employee's schedule. An employee contemplating a trade often needs to model how different scenarios will affect different aspects of his schedule, including but not limited to aspects such as pay, time off, work time, expense pay (per diem pay), trip efficiency (pay time/flight time), departure and arrival times, all nighters, time away from home, deadhead time, carryover time (when a trip carries over from one schedule period to the next), and carryover pay. A modeled scenario may appear on the calendar 806 with the visual representation of modeled shifts appearing with a different colored background and/or substantially transparent to distinguish it from a presently assigned shift. Visual representation 812 appears substantially transparent to indicate a shift presently assigned to the employee, but which would be traded away in the scenario the employee is modeling. The embodiment can perform this modeling even with complex trades that include multiple parts. Further, the employee can select all the parts of a trade, or individual parts of the trade.

FIG. 9C is a close-up view of an exemplary screen display modeling a shift trade scenario. The modeling is displayed on the calendar 806. The shift trade scenario being modeled contemplates the shift represented by visual representation 930 getting traded away for the shift represented by visual representation 932. Visual representation 930 appears substantially transparent to indicate it is modeled as being traded away. Visual representation 932 appears with a light blue background to indicate it is modeled as being traded for.

Again referring to FIG. 8, the shift summary pane 808 may display a summary of the time and pay impacts of the shifts currently displayed on the calendar. As depicted, the summary displays values for C/O Hard, C/O Pay, Hard Time, Pay Time, Protected Time, Away Time, Days Off, Expenses, Gross Pay, Hard Time, expressed in hours:minutes, is the time from when the aircraft pushes back from the gate through when it arrives at the destination gate. Pay Time, expressed in hours:minutes, indicates how much pay time the line will generate. Protected Time, expressed in hours:minutes, indicates the minimum pay value that the pilot will receive for the month, regardless of whether a trip or portion of a trip is cancelled by the company for some reason such as weather or maintenance. Away Time, expressed in hours:minutes, indicates how much time away from domicile the line will generate. Days Off is the number of days off for the month expressed as an integer. Expenses represents the expenses, or ‘per diem’ allowance, paid for the days away from home and is expressed in dollars and cents. Gross Pay is the pay that the employee can expect to be paid for the month and is expressed in dollars and cents. C/O Hard is the Hard Time that will carry over into the next month for any trips that start this month and finish in the next. C/O Pay is the Pay Time that will carry over into the next month for any trips that start this month and finish in the next. Moreover, if the user is modeling a shift trade scenario, referred to as ‘trip shopping,’ information about the current schedule may be displayed to the left in gray and information about the proposed schedule information displayed to the right in blue. Displaying the information side-by-side enables simple and efficient comparison to quickly assess the impact of a potential trade on the employee's schedule.

The listing of shifts displayed in the shift listing pane 802 of FIG. 8 may be organized in a table format with rows of the table representing shifts, similar to the listing of included shifts provided by the wizard as described above. Columns of the table represent aspects or attributes of the shifts, such as trip ID, date, number of days (for duration of the trip), departure time, Hard Time, Pay Time, Away Time, and whether the trip is a domestic or international trip. Other columns representing different aspects can be added, removed sized and sorted so that what the user displays is only the aspects of the shifts that are particularly important to him.

The set of shifts displayed and/or filtered in the listing of shifts pane 802 may be determined according to an employee selection in a navigation pane 804. The navigation pane 804 allows the employee to select various sets of shifts and other types of information to be displayed and/or filtered in the listing of shifts 802. An employee may select the set of available shifts as depicted in FIG. 8, the set of all possible shifts, the set of the employee's presently assigned shifts. Available shifts may display those shifts that are presently unassigned or that are being offered for trades. All shifts may display all possible shifts. My shifts may display the shifts assigned to the employee for a given scheduling period.

The navigation pane 804 may also enable an employee to select and view displays for various other types of information, including posts to a bulletin board and various types of trade requests. Selecting “My Big Pick” in the navigation pane 804 will cause the listing of shifts 802 to display shifts selected by the employee for a Big Pick. A “Big Pick” is one name given for an employer-facilitated, seniority-based trade period during which the employer collects all trade requests and runs down them in order of employee seniority attempting to match the most senior employee's desires and then moving onto the next senior employee, and so on, down to the most junior employee.

Selecting “My Daily Trades” in the navigation pane 804 will cause the listing of shifts 802 to display shifts selected by the employee for daily trading. Daily trading generally opens after a Big Pick rundown and is generally NOT seniority based. Daily trades may be run based on the time that the trade request was submitted according to a timestamp, essentially amounting to first-come-first-serve priority. In some currently available systems, an employee must retype all his trade requests and entering trade requests cannot even be started until after the Daily. Trading window opens. In one embodiment of the present disclosure, an employee may simply click a “submit” button and previously prepared trades are uploaded in rapid-fire fashion allowing for the earliest possible time stamp, giving the best chance for a successful trade.

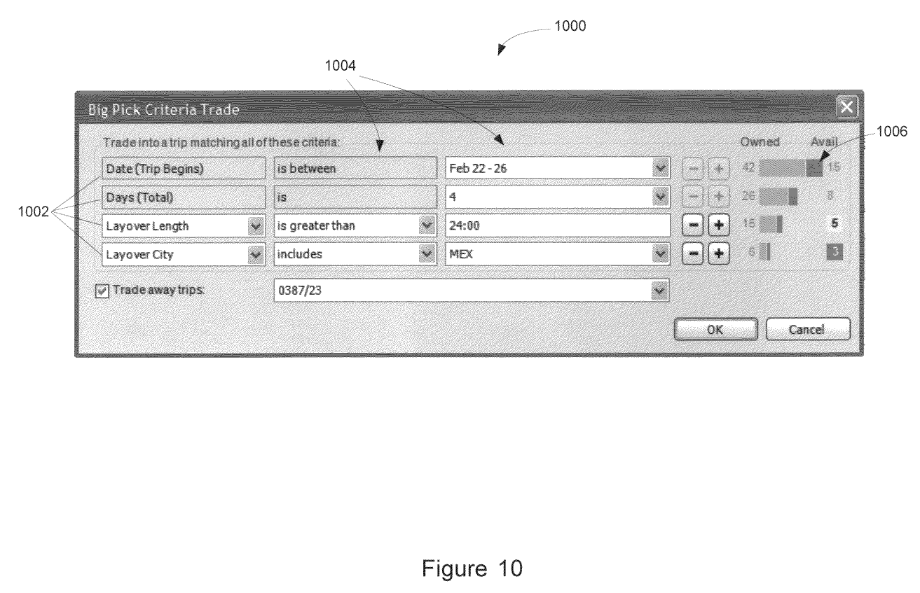

Once a set of shifts is selected to be displayed in the shift listing pane 802, the listing of shifts can also be filtered and sorted. The schedule improvement user interface 800 may enable an employee to specify criteria to filter the set of shifts being displayed by the shift listing pane 802 to thereby identify desirable shifts to trade. FIG. 10 depicts a display 1000 enabling an employee to specify filter criteria for identifying desirable shifts to trade. Display 1000 may be included as a part of schedule improvement user interface 800, or it may pop-up as a separate display when an employee desires to filter the listing of shifts 802. Display 1000 may include one or more criteria fields 1002 in which a user can specify filter criteria. Additional fields 1004 may enable the user to further define the criteria. As shown in FIG. 10, filter criteria may include, but are not limited to, the date a shift begins, the length of a shift in days, layover length, and layover city. Filter criteria may be combined as desired to specify the characteristics of shifts to be targeted for a trade.

The display 1000 may further provide the employee with a visual representation that facilitates understanding, in real-time, while specifying the filter criteria, how each criteria affects the likelihood of finding a matching shift. As shown in FIG. 10, one way to portray the likelihood of a match is with a bar graph 1006 showing the number of trips currently owned (or assigned), and the number of trips available in relation to each criteria. Further, the bar graph 1006 may indicate the number of trips owned and/or available in relation to the specific criteria in combination with all previously specified criteria. As an employee adds new criteria, the bar graph 1006 on the right updates to show how many possible shifts are now open, as well as the number of owned shifts that may become available through the trades of other employees.

As an example, shown in FIG. 10, there may be 42 owned trips and 15 available trips totaling 57 trips that begin between February 22 and February 26. Of those 57 trips, 26 owned trips and 8 available trips totaling 34 trips are four days long. Of those 34 trips, 15 owned and 5 available trips totaling 20 trip have a layover greater than 24 hours. Of those 20 trips, 6 owned and 3 available trips have at least one layover in Mexico. Coloring or shading the numbers may further provide quickly identifiable indication that the probability of a successful trade is low. In this embodiment, the background of the number is colored yellow when less than 10 trips match the criteria and colored red when less than 5 trips match the criteria. The visual representation of how filter criteria affect the likelihood of a successful trade enables an employee to quickly and efficiently increase the chances of improving the currently assigned schedule through a successful trade. As depicted, each specified criteria may have a corresponding bar graph to show the filtering impact on the available shifts. In another embodiment, a single bar graph may show the impact for all specified criteria collectively.

While the filter criteria are being specified, the listing of shifts may be filtered and shift listing pane 802 may display and/or update the shifts included and/or excluded by the specified criteria. Seeing the exact shifts matching the chosen criteria in addition to the match count explained above provides immediate feedback during the specifying of criteria, thereby allowing the employee to modify his criteria when appropriate if undesirable shifts are still present in the list or expected desirable shifts are absent. The display may be very similar to display 500 depicted in FIG. 5. As before, the listing of shifts 802 may list the shifts included and/or excluded by the filter criteria. Also as before, a divider may separate the included trips from the excluded trips. Thus, the employee can readily see the excluded trips that are closest to matching the filter criteria.

While specific embodiments and applications of various methods and systems for conducting experiments over the Internet have been illustrated and described, it is to be understood that the invention claimed hereinafter is not limited to the precise configuration and components disclosed. Various modifications, changes, and variations apparent to those of skill in the art may be made in the arrangement, operation, and details of the methods and systems disclosed.

Furthermore, the methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified without departing from the scope of the invention as claimed.

The embodiments disclosed may include various steps, which may be embodied in machine-executable instructions to be executed by a general-purpose or special-purpose computer (or other electronic device). Alternatively, the steps may be performed by hardware components that contain specific logic for performing the steps, or by any combination of hardware, software, and/or firmware.

Embodiments of the present invention may also be provided as a computer program product including a machine-readable medium having stored thereon instructions that may be used to program a computer (or other electronic device) to perform processes described herein. The machine-readable medium may include, but is not limited to, floppy diskettes, optical disks, CD-ROMs, DVD-ROMs, ROMs, RAMs, EPROMs, EEPROMs, magnetic or optical cards, propagation media or other type of media/machine-readable medium suitable for storing electronic instructions. For example, instructions for performing described processes may be transferred from a remote computer (e.g., a server) to a requesting computer (e.g., a client) by way of data signals embodied in a carrier wave or other propagation medium via a communication link (e.g., network connection).

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software, or combinations of both. To illustrate the interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the invention as claimed hereinafter.

What is claimed is:

1. A method for visually representing employee shifts in order to facilitate employee creation of schedule bids and shift trade requests to be submitted to a preferential bidding system, the method comprising:
displaying a horizontal bar to serve as a timeline depicting relative duration of a shift being represented and relative timing of active and inactive work periods during that shift, wherein horizontal position along the bar is proportional to time, and the length of the bar is proportional to the total duration of the shift.
varying at least one of the height and color of segments of the bar to depict the timing and type of work periods during the shift.

2. The method of claim 1, further comprising providing a calendar view in which the horizontal bar is superimposed on a calendar to indicate actual duration of the shift and actual timing of the beginning and ending of the shift and periods during the shift,
wherein the calendar comprises one or more sequentially positioned day cells that represent one or more days of a schedule period,
wherein horizontal position within a day cell is proportional to time of the day represented;
wherein the bar begins at a horizontal position within a day cell corresponding to the time of day that the shift begins, the bar ends at a horizontal position within a day cell corresponding to the time of day that the shift ends, and the length of the bar is proportional to the duration of the shift; and
wherein the segments of the bar, with at least one of height and color of the bar changed to depict timing and type of work periods, are positioned on the calendar to indicate actual time of day of each work period during the shift such that a bar segment begins at a horizontal position corresponding to the time of day that the represented work period begins, the bar segment ends at a horizontal position corresponding to the time of day that the represented work period ends, and the length of the bar segment is proportional to the duration of the work period represented.

3. The method of claim 1, wherein the different types of active and inactive periods during the shift include at least one of on-duty time, break time, and on-call time.

4. The method of claim 1, wherein a shift comprises a trip having one or more segments, wherein the employee is on the clock and compensated for time spent through the duration of the trip.

5. The method of claim 4, wherein the different types of active and inactive periods during the shift include at least one of working travel time, working travel time during a trip through the night, non-working travel time, layover time, between-segment layover time, and debrief time.

6. The method of claim 4, wherein the trip comprises an airline trip having one or more flights, wherein the last flight returns to the location of departure of the first flight.

7. The method of claim 6, wherein the different types of active and inactive periods during the shift include at least one of work time during a flight, work time during a flight through the night, deadhead time, layover time, between-flight layover time, and debrief time.

8. The method of claim 4, wherein the trip comprises one of a bus trip, a train trip, a trucking haul, a cruise, and a space flight.

9. The method of claim 4, further comprising indicating layover cities during the trip.

10. The method of claim 1, further comprising displaying a shift id number.

11. The method of claim 1, further comprising indicating textually at least one of shift start time, shift duration, and shift end time.

12. The method of claim 1, further comprising indicating whether or not the shift has been assigned to an employee.

13. The method of claim 1, further comprising changing the texture of segments of the bar to indicate the timing of different types of active and inactive periods during the shift.

14. The method of claim 1, further comprising displaying total hours and total pay for one or more shifts being represented.

15. A computer-readable storage medium comprising instructions for causing a computer to perform a method for visually representing employee shifts in order to facilitate employee creation of schedule bids and shift trade requests to be submitted to a preferential bidding system, the method comprising:
displaying a horizontal bar to serve as a timeline depicting relative duration of a shift being represented and relative timing of active and inactive work periods during that shift, wherein horizontal position along the bar is proportional to time, and the length of the bar is proportional to the total duration of the shift.
varying at least one of the height and color of segments of the bar to depict the timing and type of work periods during the shift.

16. The computer-readable storage medium of claim 15, wherein the method further comprises
superimposing the horizontal bar on a calendar to indicate actual duration of the shift and actual timing of the beginning and ending of the shift and periods during the shift,
wherein the calendar comprises one or more sequentially positioned day cells that represent one or more days of a schedule period,
wherein horizontal position within a day cell is proportional to time of the day represented;
wherein the bar begins at a horizontal position within a day cell corresponding to the time of day that the shift begins, the bar ends at a horizontal position within a day cell corresponding to the time of day that the shift ends, and the length of the bar is proportional to the duration of the shift; and
wherein the segments of the bar, with at least one of height and color of the bar changed to depict timing and type of work periods, are positioned on the calendar to indicate actual time of day of each work period during the shift such that a bar segment begins at a horizontal position corresponding to the time of day that the represented work period begins, the bar segment ends at a horizontal position corresponding to the time of day that the represented work period ends, and the length of the bar segment is proportional to the duration of the work period represented.

17. The computer-readable storage medium of claim 15, wherein a shift comprises an airline trip having one or more flights, wherein the employee is on the clock and compensated for the entire duration of the trip.

18. The computer readable storage medium of claim 15, wherein the different types of active and inactive work periods during the shift include at least one of work time during a flight, work time during a flight through the night, deadhead time, layover time, between-flight layover time, and debrief time.

19. A computer-implemented method for facilitating employee creation of schedule bids and shift trade requests to be submitted to a preferential bidding system, the method providing on-the-fly filtering of shifts in order to show the shifts that match employee-designated criteria, the method comprising:
receiving a description of all possible shifts an employee may be assigned;
presenting to the employee one or more filter criteria that the employee may designate to be used by the method for identifying shifts that may be desirable to the employee;
receiving from the employee a designation of a filter criterion;
applying the designated criterion, and any previously designated criteria, to the possible shifts to identify which shifts match the designated criteria and thus may be desirable to the employee; and
displaying to the employee an indication of possible shifts that match the designated criteria.

20. The method of claim 19, wherein displaying indication of matching shifts comprises displaying the number of possible shifts that match the criteria.

21. The method of claim 19, wherein displaying indication of matching shifts comprises displaying the number of presently owned shifts that match the criteria and the number of presently available shifts that match the criteria.

22. The method of claim 19, wherein displaying indication of matching shifts comprises displaying a list of the possible shifts that match the criteria.

23. The method of claim 19, wherein displaying indication of matching shifts comprises displaying a listing of all possible shifts in order of relevance to the criteria with a divider separating included shifts that match the criteria from excluded shifts that don't match the criteria, wherein included shifts are listed on one side of the divider and excluded shifts are listed on the opposite side of the divider.

24. The method of claim 19, wherein displaying indication of matching shifts comprises displaying the number of possible shifts that match the criteria for each particular criterion, wherein the number of matching shifts for a particular criterion is the number of shifts from the set of shifts identified by any previous criteria.

25. A method for facilitating employee creation of schedule bids and shift trade requests to be submitted to a preferential bidding system, the method comprising:
receiving from an employer scheduling system a description of possible shifts an employee may be assigned to fill;
presenting to the employee one or more filter criteria that the employee may designate to be used for identifying desirable shifts; and
providing on-the-fly filtering of to show shifts matching employee-designated criteria, providing on-the-fly filtering comprising
receiving from the employee a designation of a filter criteria,
applying the criteria to the possible shifts to determine which shifts match the designation, and
displaying to the employee an indication of which of the possible shifts match the designation; and
providing a visual representation the shifts to enhance the employee's ability to quickly ascertain shift characteristics and thereby identify desirable shifts, providing the visual representation comprising
displaying a horizontal bar to serve as a timeline depicting relative duration of the shift and relative timing of periods during the shift, wherein horizontal position along the bar is proportional to time, and the length of the bar is proportional to the total duration of the shift, and
varying at least one of the height and color of segments of the bar to depict the timing of different types of active and inactive periods during the shift.

26. A system for facilitating employee creation of schedule bids and shift trade requests to be submitted to a preferential bidding system, the system comprising:
a storage component for storing a description of possible shifts an employee may be assigned to fill;
a criteria display component to present to the employee one or more filter criteria that the employee may select to be used to identify desirable shifts and enabling the employee to designate the one or more of the criteria;
a filtering component to provide on-the-fly filtering of shifts to show shifts matching the criteria designated by the employee, wherein the filtering component receives from the employee a designation of a filter criteria, applies the criteria to the possible shifts stored in the storage component to determine which shifts match the designation, and provides the possible shifts that match the designation; and
a shift display component to present to the employee a concise visual depiction of the shifts, the shift display comprising a horizontal bar representing a shift and that serves as a timeline to depict relative duration of the shift and relative timing of periods during the shift, wherein horizontal position along the bar is proportional to time, and the length of the bar is proportional to the total duration of the shift, and wherein at least one of the height and color of segments of the bar are varied to depict relative timing and type of active and inactive work periods during the shift

27. The system of claim 26, wherein the shift display component further comprises a calendar having one or more sequentially positioned day cells that represent one or more days of a schedule period,
wherein horizontal position within a day cell is proportional to time of the day represented;
wherein the bar is superimposed on the calendar to indicate actual duration of the shift and actual timing of the beginning and ending of the shift and periods during the shift,
wherein the bar begins at a horizontal position within a day cell corresponding to the time of day that the shift begins and ending at a horizontal position within a day cell corresponding to the time of day that the shift ends such that the length of the bar is proportional to the duration of the shift; and
wherein the segments of the bar, with at least one of height and color of the bar changed to depict timing and type of active and inactive work periods, are positioned on the calendar to indicate actual time of day of the different work periods during the shift such that a bar segment begins at a horizontal position corresponding to the time of day that the represented work period begins, the bars segment ends at a horizontal position corresponding to the time of day that the represented work period ends, and the length of the bar segment is proportional to the duration of the work period represented.
